(19) United States
(12) Patent Application Publication
(10) Pub. No.: US 2004/0095326 A1
(43) Pub. Date: May 20, 2004

(54) Two-sided input device for a computer-related apparatus

(76) Inventor: Glen J. Anderson, Sioux City, IA (US)

Correspondence Address: GATEWAY, INC., ATTN: SCOTT CHARLES RICHARDSON, 610 GATEWAY DRIVE, MAIL DROP Y-04, NORTH SIOUX CITY, SD, 57049, US

(21) Appl. No.: 10/611,728

(22) Filed: Jul. 1, 2003

Related U.S. Application Data
(63) Continuation-in-part of application No. 09/362,006, filed on Jul. 27, 1999, now Pat. No. 6,587,094.

(51) Int. Cl. G09G 5/00

(52) U.S. Cl. 345/168

(57) ABSTRACT

A multi-sided keyboard or other input/control device has at least two sets of input controls mounted so that their respective input controls can be selective accessed. Each of the sets of input controls corresponds to a different computer application or computer-related device, including different language characters, different input controls, and different key configurations. In the case of a two-sided input device, two sets of input controls are mounted in a single module which can be flipped or rotated so that the desired input control set faces up.

### FIELD OF THE INVENTION

This invention relates to input devices, such as keyboards for computers, and more particularly, to an improved keyboard having increased functionality.

### BACKGROUND

As computer processing power increases, so do the complexity and number of associated software applications. Such computer applications, in turn, are increasingly associated with more involved and more numerous command sequences. For example, computer-aided design applications, which were once uniquely the province of so-called “main-frame” computers or other large systems, are now routinely available on personal computers and even laptops.

The increased complexity of software applications has generated a need for specialized inputs into such applications. For example, in today's highly interactive and realistic computer games and other entertainment applications, the user needs to drive, fly, or navigate a three dimensional world, often while warding off numerous assaults or pursuing desired treasure or quarry. Similarly, computer-related devices themselves are becoming more specialized tools, thus generating a corresponding need for specialized input devices.

As computers become more prevalent, certain users desire so-called “ergonomic” or other non-standard key layouts for the keyboards. Similarly, children and special needs individuals may require non-standard keyboards in order to effectively operate the associated computer-related device.

The continuing trend toward globalization often requires computer users to make use of foreign characters while operating computer applications. As the worldwide interconnection of computers increases, there will be a corresponding increased need to switch between character sets of different languages. This need is all the more acute in in multinational enterprises needing to trade or communicate in local languages where business is being conducted.

The standard computer keyboard has sometimes been unable to address the above-described increases in application specialization and complexity. As a result, many advanced commands or functions are unduly involved, cumbersome to remember, or otherwise difficult to execute with a standard computer keyboard.

There have been various attempts to improve this situation, which have had mixed results. One approach of the current art is to increasingly place commands and functions on the graphical user interface, such as in the form of command buttons. To execute such commands, however, requires the user to remove his or her hand from the keyboard, grasp the mouse or other pointing device, move the cursor to the desired command button, “click” the activation button on the mouse a requisite number of times, and only after this sequence can the user return his or her hand to the keyboard for further processing. This sequence can undesirably interrupt the flow of operating the application, playing the computer game, etc.

Another approach has been to create specialized keyboards for specialized applications. For example, computer game systems or computer games running on a personal computer often assemble joysticks, triggers, firing buttons and other input devices on a special “game keyboard” dedicated specifically to the operation of the corresponding computer game.

Other specialized computer-related devices come equipped with their own distinctive input controls or keyboards. Examples of this trend include keyboards for navigating the World Wide Web, or those associated with personal digital assistants. A related approach is disclosed in U.S. Pat. No. 5,136,694 (Belt) which discloses a circuit for switching between the built-in keyboard, such as in a laptop, and the “full function” keyboard typically associated with a desktop computer.

The foregoing approaches disadvantageously require the purchase of a second or specialized keyboard or keyboard add-ons, separate from a standard keyboard. Such additional purchases not only take up space, but the user needs to remember where the additional keyboards are stored, so they can be accessed when the appropriate application is utilized.

Another approach is disclosed in U.S. Pat. No. 4,633,227 (Menn), which discloses a programmable keyboard in which a standard configuration of keys can be associated with two or more sets of characters. In order to activate an alternative character set, the user must go through the time and trouble of reprogramming the keyboard. Another disadvantage of this approach is that the key configurations must remain in the standard computer keyboard layout. As a result, the alternate character sets generally cannot have more characters than does English without resorting to cumbersome improvisations to include the additional characters. This makes keyboards for Kanji, Russian, and other non-Roman alphabet languages generally awkward to use. Furthermore, other specialized needs, such as those associated with computer games, cannot generally be configured within the confines of a standard keyboard.

Computer-related apparatus are likewise increasing in functionality. For example, a computer-related apparatus may comprise multiple electronic subsystems, each subsystem having its own associated set of operations or functions. Sometimes, these electronic subsystems have previously been separate, stand-alone systems. But the trend to convergence has meant there are now electronic subsystems forming part of larger multi-media systems. Multi-media systems may take on myriad different forms. For example, multi-media systems currently exist which incorporate not only a computer with associated software applications or access to the internet, but also a DVD/CD player (sometimes incorporated into the computer itself), a television system, and even at times a game system or console. In such convergence or multi-media systems, different electronic subsystems sometimes overlap or share pieces of hardware, such as displays, drives, communications, connections, and the like.

The increased complexity of such multi-media systems and other similar computer-related apparatus has seen a corresponding increase in the complexity of input controls. Attempts at expanding or enhancing remotes for such systems, for example, have sometimes resulted in a bewildering array of buttons, often with difficult-to-understand labels, alternate markings, and thus a certain amount of uncertainly associated with which functions of the multi-media system are performed by which button.

There is thus a need for an input device with the flexibility to accommodate the increased complexity and specialization of today's and tomorrow's computer-related apparatuses.

There is a further need for this flexibility not only to be relatively straightforward to implement by the user, but also relatively economical.

### SUMMARY OF THE INVENTION

According to one aspect of the invention, a multi-sided input device useful for operating one or more corresponding computer-related apparatuses has at least two sets of input controls. The input controls are disposed on two, opposite surfaces of a module. The input device includes a base which has portions defined so that the input device can move relative to the base, either by being separated from the base or by being rotated relative to it.

According to another aspect of the invention, the computer-related apparatus comprises a combination PDA-cellphone. The module of the input device has a generally planar configuration. One set of input controls is the keypad for the cellphone and the second is the touchpad for the PDA.

In accordance with still another aspect of the present invention, a multi-sided input device has at least three sets of input controls, each set sufficient to operate at least one electronic apparatus.

In accordance with another aspect of the invention, the multi-sided input device is part of a multi-media system, the system having a plurality of electronic subsystems for reading or processing information from corresponding information sources. The input device has corresponding sets of input controls for operating the subsystems of the multi-media system. The multi-media system can take on a variety of forms, including one or more of the following: a computer, a television, a CD/DVD player, a stereo, and a game console.

### BRIEF DESCRIPTION OF THE DRAWINGS

The invention will be better understood by reference to the attached drawing. It is understood that the drawing is for illustrative purposes only and is not necessarily drawn to scale. In fact, certain features of the drawing are shown in more detail for purposes of explanation and clarification.

FIG. 1 is an exploded, perspective view of a computer-related apparatus and associated input device in the form of a keyboard according to the present invention;

FIG. 2 is a side sectional view of the keyboard of FIG. 1;

FIG. 3 is a bottom plan view of the keyboard of FIGS. 1 and 2;

FIG. 4 is an enlarged, partial, exploded, side sectional view of the keyboard module of FIG. 2;

FIG. 5 is a perspective view of a first alternative embodiment of an input control device according to the present invention;

FIG. 6 is a perspective view of a second alternative embodiment of an input control device according to the present invention;

FIG. 7 is a side elevational view of the keyboard of FIG. 6;

FIG. 8 is a perspective, partial view of a third alternative embodiment of an input control device according to the present invention;

FIG. 9 is a partial, sectional view of the embodiment of Fig;

FIGS. 10A-C are perspective views of a fourth alternative embodiment of the invention, showing a multi-sided input control device;

FIGS. 11A-11C are front, elevational views of a fifth alternative embodiment of the invention showing a computer-related apparatus and input control device;

FIGS. 12A-12C are front, elevational views of a sixth alternative embodiment of the invention showing another computer-related apparatus and another input control device according to the present invention;

FIGS. 13A and 13B are front and rear elevational views of a seventh alternative embodiment of a computer-related apparatus and input control device according to the present invention; and

FIGS. 14A and 14B are front and rear elevational views of an eighth alternative embodiment of the invention, showing still another computer-related apparatus and input control device.

### DESCRIPTION OF THE PREFERRED EMBODIMENTS

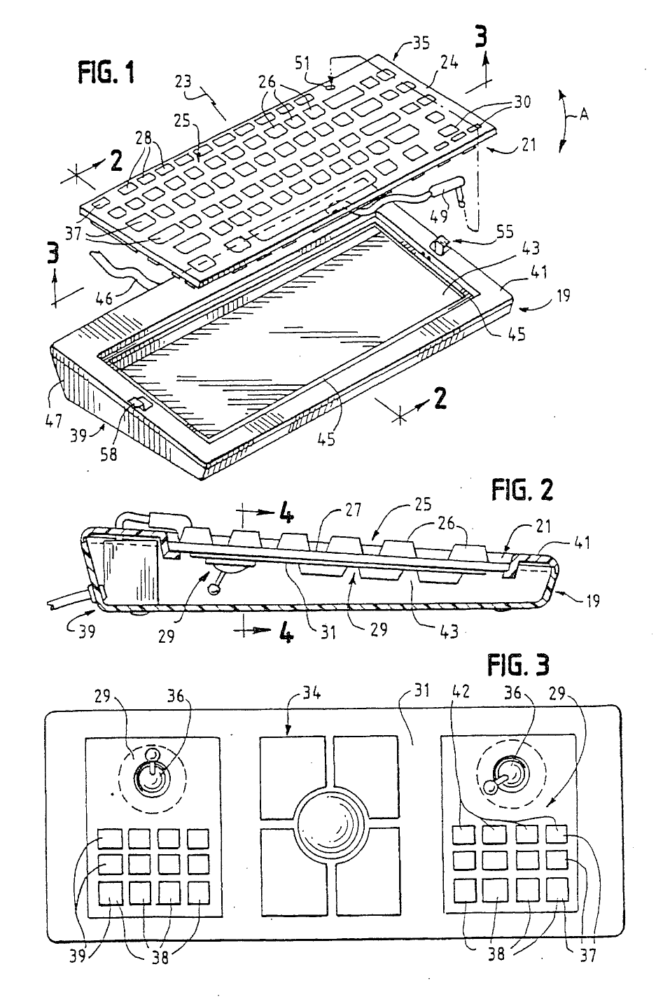

Referring now to the drawing, and in particular to FIGS. 1-4, a two-sided input device 19 in the form of a keyboard 21 is shown in conjunction with a computer-related apparatus, such as the personal computer shown schematically at 23. Input device 19 has a first set of input controls 25 movably mounted on and extending outwardly from a corresponding surface 27, and a second set of input controls 29 movably mounted on and extending outwardly from an opposite surface 31. Input controls 29 in the illustrated embodiment are in the form of alphanumeric keys 26, function keys 28, and cursor control keys 30. However, the term “input controls,” as used herein is not limited to keys on a keyboard, but rather is a broad term encompassing any of the myriad expedients for a user to input data or commands into the device 19, including a mouse, trackball, touchpad, joystick, button, and the like.

As best seen in FIG. 4, suitable circuitry, preferably in the form of circuit boards 33, is operatively connected to input controls 25, 29 and mounted to a substrate 44. As such, the first and second sets of input controls 25, 29, circuit boards 33 connected thereto, and substrate 44 together comprise a generally planar keyboard or input control module 35, which the user can flip in the directions of arrows A, so that the desired set of input control sets 25, 29 is facing upward and is thus accessible, while the other set is facing away from the user and is less accessible. In this way, a user can easily switch between two, alternate sets of input controls, one set being suitable for a first set of applications, and the other set being more appropriate for a second set of applications or a second user.

Input control set 25 is a relatively standard QWERTY keyboard with cursor movement keys 30 and function keys 28, discussed above. In contrast, however, as seen in FIG. 3, set 29 of input controls is a specialized keyboard 34 suitable for one or more computer games. As such, keyboard 34 includes a trackball 32, joysticks 36, navigational controls 38, hot keys 40, and firing buttons 42. Significantly, each of the sets 25, 29 has a sufficient number of input controls 37 to operate corresponding software applications running on personal computer 23.

Irrespective of which set of input controls 25, 29 is facing toward the user, module 35 rests on base 39 during use. In this embodiment, base 39 has a generally rectangular footprint to give input device 19 the required stability, and an upper surface 41 which slopes downwardly to one longitudinal side so that input control module 35 is slightly tilted toward the user. A cavity 43 is defined in upper surface 41 and is bounded by outwardly oriented edges 45. Module 35 is physically supported on at least portions of outwardly oriented edges 45 and, in such position, the bottom-facing set of input controls 29 extend partly into cavity 43 (FIG. 2) and are therefore hidden by perimeter wall 47 of base 39.

A pair of mating connectors 49 and 51 electrically connects module 35 to base 39. Each set of input controls 25, 29 has a corresponding female connector 51 (one of which is shown). Electrical connector 49 is secured to base 39 and is received in the selected one of connectors 51. Base 39, in turn, has a suitable electrical connection 46 to the personal computer 23. Thus, whichever set of input controls 25, 29 is being used can be connected to computer 23.

Module 35 is preferably formed of relatively thin keyboard subassemblies, such as those frequently found on laptop computers. In this way, the overall thickness of module 35 is minimized. Base 39 optionally includes means for holding module 35 in position, here shown as a plurality of latches 55. Module 35 is secured adequately to base 39 when snapped into place so that latches 55 engage the outwardly-facing surface 27 or 31 of module 35.

Although the various input controls 37 can be operatively connected to circuit boards 33 by any suitable means, one preferred structure is shown in FIG. 4 for a subset of alphanumeric keys 26 and one of the joysticks 36. One circuit board 33 is secured to a corresponding one of the opposite surfaces 60 of substrate 44. A resilient layer 57 is disposed on the surface of each circuit board 33 and positioned so that contacts 59 formed on underside 61 of resilient layer 57 are positioned over appropriate conductive portions of circuit boards 33. Resiliently compressible layer 65 is in turn disposed over resilient layer 57. Underside 67 of layer 65 is suitably formed to mate with topside 62 of resilient layer 57. Key caps 69 have upper surfaces 71 which are contacted by the user, and undersides 73 which mate with top sides 66 of resilient layer 65. The resulting multi-layer structure provides for the appropriate electrical connection to be made with circuit board 33 while at the same time providing the desired tactile feedback. Circuit boards 33 are equipped with suitable electronics for detecting movements of the input controls. When input controls are activated, such movements are transmitted via circuitry and electronic components on the appropriate circuit board 33 through base 39 and into the chassis of personal computer 23.

It will be appreciated that the sets of input controls 25, 29 of module 35 can assume a wide variety of configurations and combinations depending on the intended applications and the needs of the anticipated users. In one alternative to that illustrated and discussed above, input control sets 25, 29 can correspond to two alphanumeric keyboards for two different languages. As further alternatives, the sets of input controls 25, 29 can include an ergonomic keyboard, a keyboard for special needs individuals, a keyboard specially configured for browsing on a computer network, or a keyboard with large-key or picture-key configurations for children.

The operation of the two-sided keyboard of the present invention is apparent from the foregoing description. When the user wishes to switch to the bottom-facing, inaccessible keyboard, to run a particular application or game, for example, the user first undoes latches 55, if base 39 has been so provided. Connector 49 is disconnected from the connector 51 of the keyboard which was previously being used. Keyboard module 35 is then separated from base 39, flipped over so that the keyboard previously received in cavity 43 is now facing up, and then replaced on base 39. In this position, the keyboard previously hidden is now accessible, and the one previously accessible is now hidden. The connector 49 is reinserted into the connector 51 corresponding to the upward facing keyboard, and the user can input data or transmit commands to computer 23 from the new, accessible keyboard. The hidden keyboard is no longer electrically connected to the computer 23, so false activation of its keys cannot occur. There is no need to alter the connection between base 39 and computer 23 during the foregoing operations.

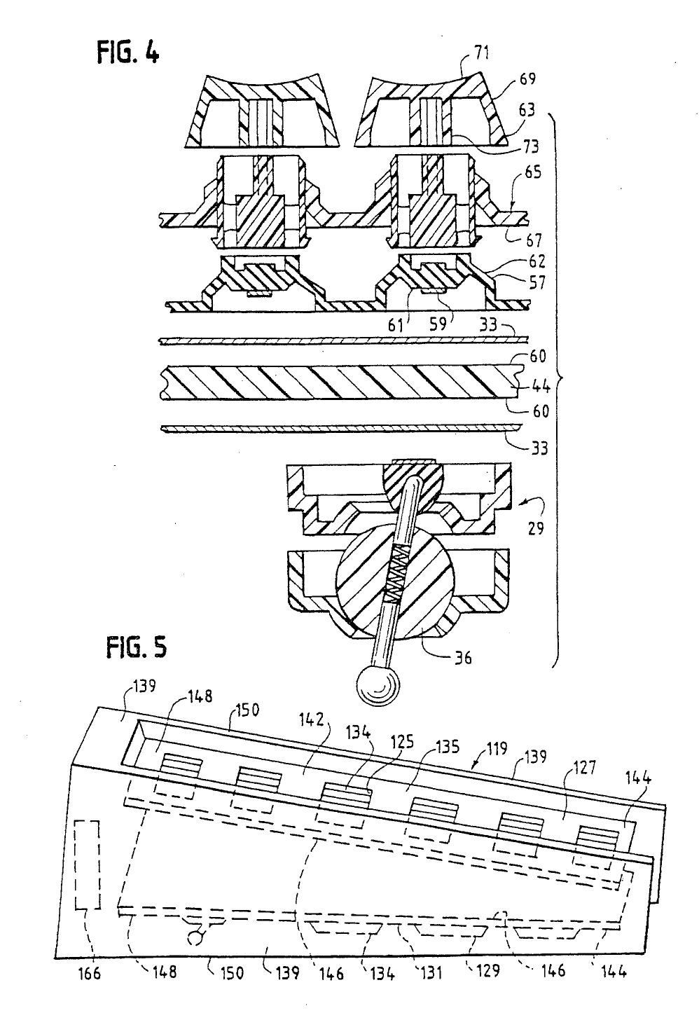

There are alternative ways to support module 35 relative to the user. One such alternative is shown in FIG. 5. Instead of a separate base 39, module 135 has a substantially rigid member 139 located at both, opposite ends 142 and rear 143 of module 135. The two keyboards 134 of module 135 are mounted relative to each other so as to be substantially back-to-back. The term “substantially back-to-back,” as used with reference to this embodiment, means that back surfaces 146 oppose each other but may optionally be tilted relative to each other so that forward edges 144 of respective keyboards 134 are closer to each other than corresponding rear edges 148. This substantially back-to-back configuration has the advantage of tilting the upper keyboard 134 toward the user, as made more apparent below.

Rigid member 139 extends outwardly from keyboard surfaces 127, 131 and terminates in respective, outer edges 150 which follow the general tilt of keyboard surfaces 127, 131. The resulting two-sided input device 119 rests on the downwardly facing outer edges 150, thereby holding the upwardly facing set of input controls 125 or 129 in a relatively stable position for use. Preferably, rigid member 139 extends sufficiently so that outer edges 150 are equal to or greater than the corresponding, outward extension of the input controls from surfaces 127, 131. In this way, rigid member 139 keeps the input controls of the bottom-facing keyboard from contacting the surface on which two-sided input device 119 rests.

In order to electrically connect only the upwardly facing keyboard to the computer related apparatus, a gravity switch 166 is operatively connected to corresponding sets of input controls 125, 129. Gravity switch 166 functions in a manner known in the art, that is, it responds to rotation of module 135 to activate that set of input controls which is in the upwardly-facing, accessible position.

The user selects the keyboard he or she wishes to use by flipping the device 119 to place the desired keyboard in the upwardly facing position.

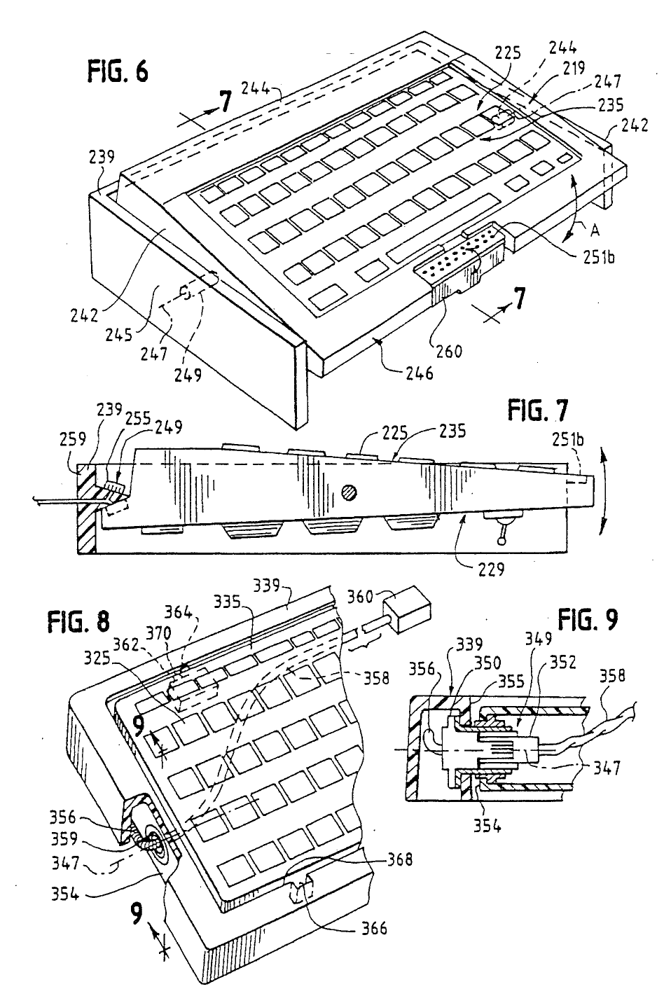

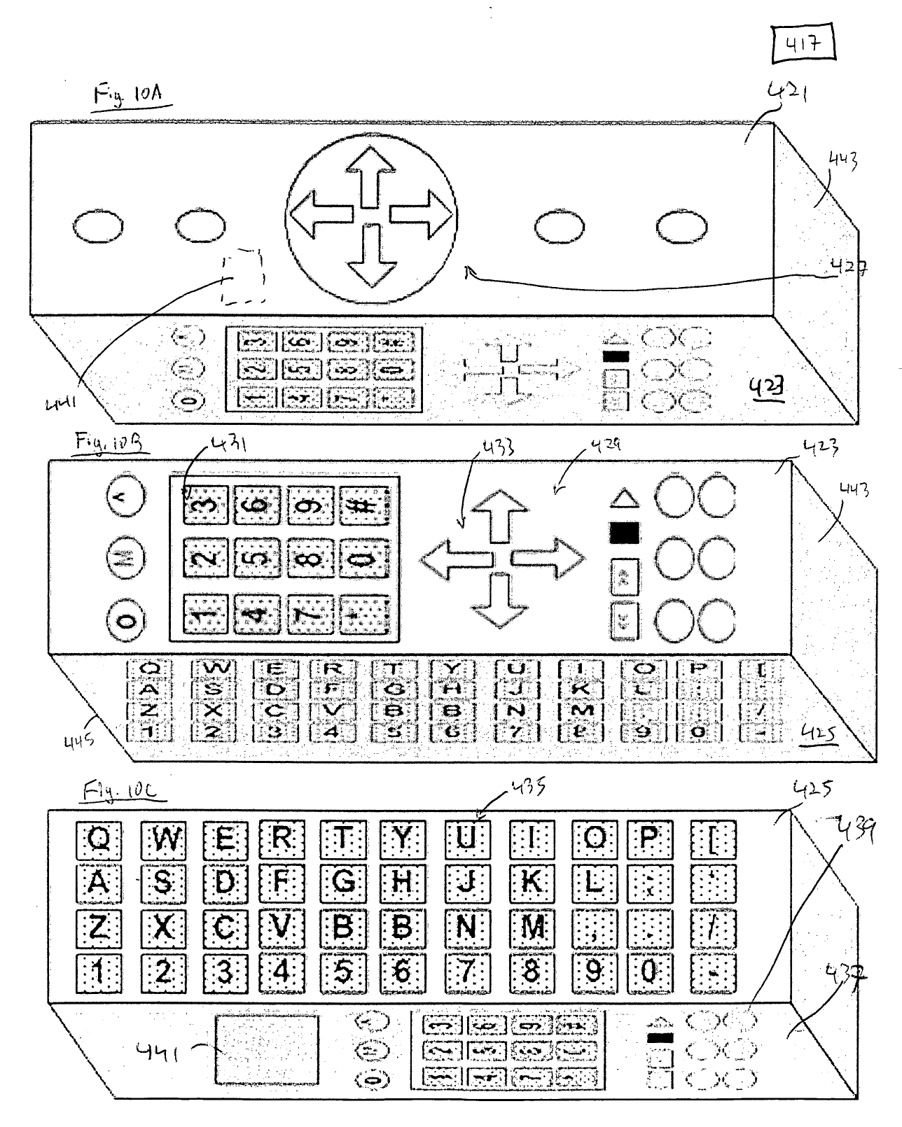

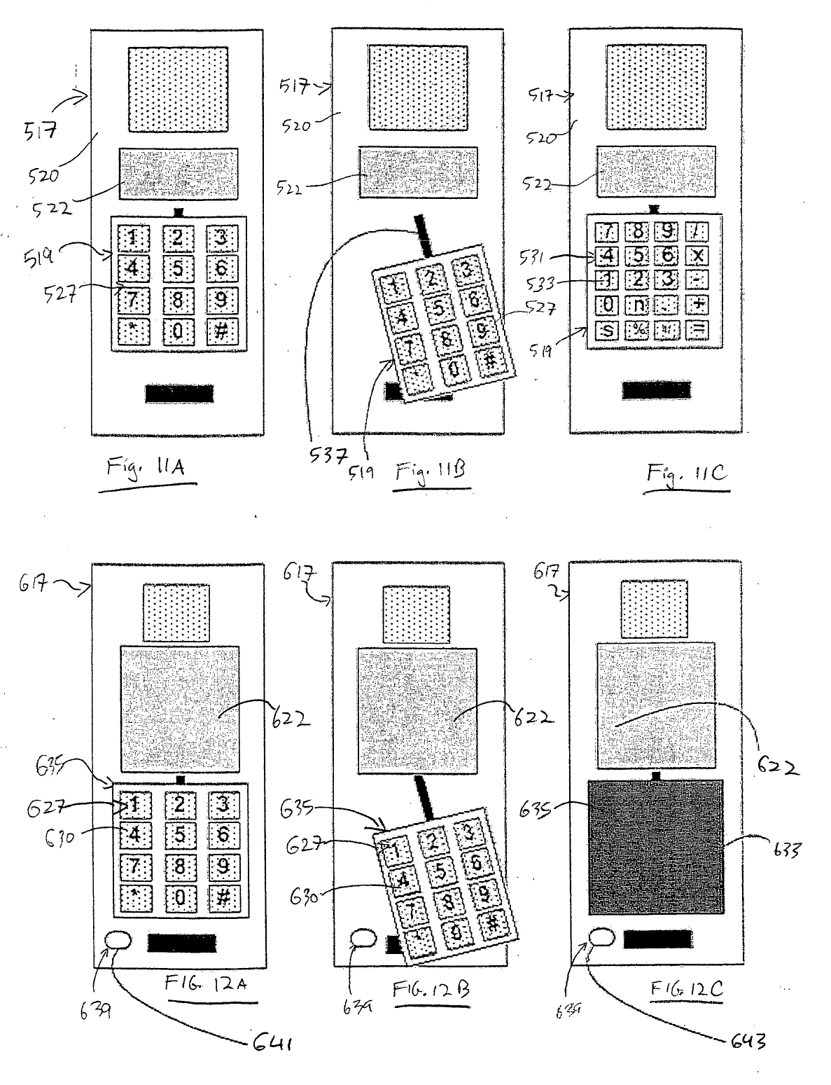

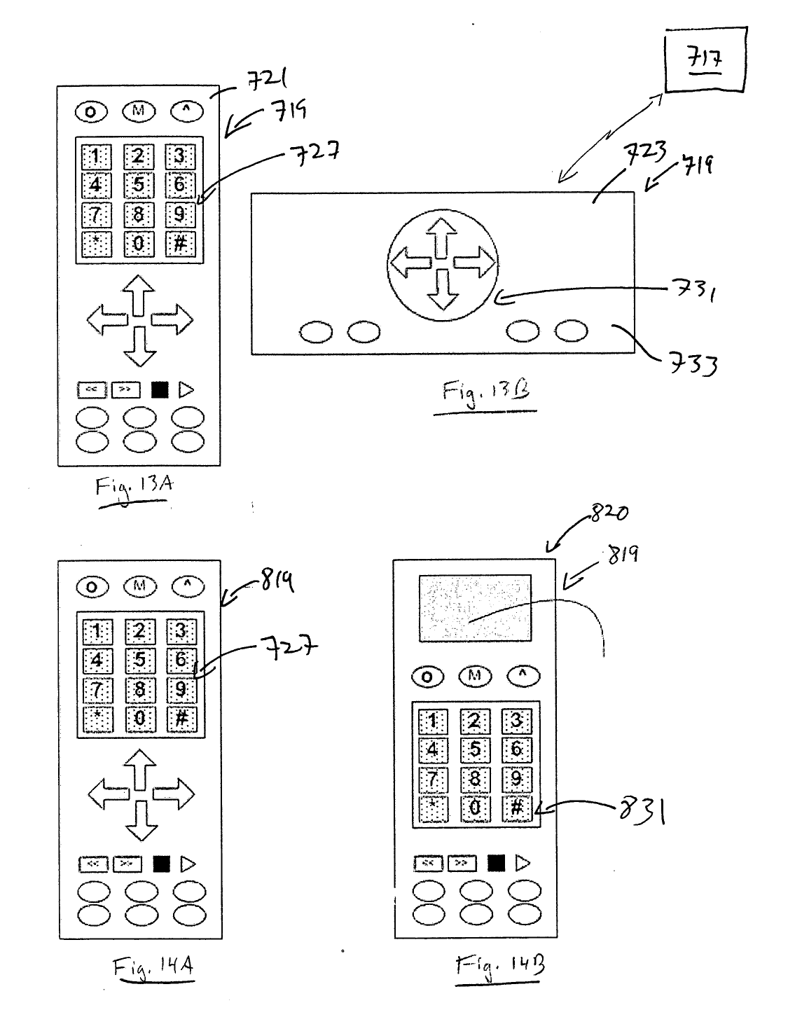

A second alternative embodiment of the present invention, shown in FIGS. 6 and 7, includes a peripheral bezel 239 which extends along top and side edges 244, 242, respectively, of module 235. As in the previous alternative embodiment shown in FIG. 5, peripheral bezel 239 has a sufficient height to keep the bottom-facing set of input controls from encountering the opposing surface. Module 235 is rotatably mounted by any suitable means to opposite sidewalls 245 of peripheral bezel 239. A pivot axis 247 extends between the pair of mounting locations 249. The user pivots module 235 about pivot axis 247 in the directions shown by arrow B to place the desired set of input controls 225, 229 in the accessible position.

The two-sided input device 219 of FIGS. 6 and 7 has structures similar to the embodiment of FIGS. 1-4 for electrically connecting the desired set of input controls 225, 229 to the corresponding computer-related apparatus. In particular, a two-sided connector 249 extends from the back wall of bezel 239. Input controls 225 are connected to connector 251a defined at a suitable location in top edge 244 (as shown in FIGS. 6 and 7). Two-sided connector 249 has a downwardly facing pinset 257 which engages connector 251 to electrically connect set 225 of input controls as shown in FIGS. 6 and 7. Connector 251b is mounted at forward edge 246 (as shown in FIGS. 6 and 7) and connects to input controls 229. To connect the connector 251b to the two-sided connector 249, edge 246 is rotated upwardly in the direction of upward arrow B. Edge 244 is structured so that it slides past two-sided connector 249. After passing through an arc of about 180°, set 229 of input controls faces upwardly (not shown) and connector 25b is received in pins 255 of two-sided connector 249 to complete the required connection.

Connector 251b is equipped with a door 260, shown open in FIG. 6, which covers connector 251b when it is facing upwardly and not in use as in FIG. 6.

Operation of input control device 219 is apparent from the foregoing. The user rotates the keyboard module 235 in the directions of arrows B depending on which set of controls 225, 229 he or she wishes to activate. The module 235 is rotated until the appropriate connector 251a, 251b engages the corresponding pins of two-sided connector 249.

Yet another alternative embodiment of the present invention, shown in FIGS. 8 and 9, includes a rotatable module 335, similar to keyboard module 235 of the previous embodiment shown in FIGS. 6 and 7, but with an alternative means for connecting keyboard module 335 to peripheral bezel 339. In general terms, the embodiment illustrated in FIGS. 8 and 9 includes an electrical connector 349 which is located along pivot axis 347 of keyboard module 335. Electrical connector 349 is preferably a PS2 connector frequently used in keyboards. Electrical connector 349 has opposing male and female portions 350, 352 which are interconnected and extend between the bezel 339 on the one and an opposing one of the vertical walls 354 on the other hand.

A suitable electrical cable 356 extends from the male portion 350 of connector 349 to connect the keyboard module 335 to a computer-related device (not shown). A corresponding cable 358 extends from the female portion 352 of connector 349 and extends to keyboard module input 360 located in the upper right hand corner of keyboard module 335, as is often the case in standard keyboard configurations.

Suitable bores, one of which is shown at 359, are formed in the opposing vertical walls 354, 355 to enable the male and female portions 350,352 of electrical connector 349 to be appropriately secured between bezel 339 and keyboard module 335. The bores 359 are axially aligned with pivot axis 347 and are equipped with suitable collars or shrouds so that module 335 rotates not only about pivot axis 347, but also about the axially aligned connector 349.

Significantly, cable 358 has sufficient slack between connector 349 and keyboard module input 360 so that keyboard module 335 is able to be rotated at least 180 degrees without causing cable 358 to bind or otherwise inhibit rotation of the keyboard module 335. In this way, it will be appreciated that keyboard module 335 can be of the two-sided variety as discussed above, and that one or the other of the keyboards can be rotated to the accessible, upper position for suitable input by a user.

In this embodiment, the means for detecting which side of keyboard module 335 is “active” includes a switch 362 with a button 364 extending outwardly and spring biased outwardly from active surface 370 of switch 362. In the position shown in FIG. 8, a relatively standard keyboard 325 is in the upper, accessible position, and button 364 of switch 362 is depressed by virtue of contact with an opposing portion of bezel 339. Conversely, when keyboard module 335 is rotated from its position shown in FIG. 8, button 364 ceases to be depressed, and extend outwardly by virtue of its spring bias. When keyboard module 335 is rotated about 180° from its position shown in FIG. 8, then keyboard 325 is in an inaccessible position, and the other keyboard (not shown) on the opposite face of module 335 faces upwardly. In this second position, the outwardly extending button 364 is received in its non-depressed state in cavity 366, which cavity is located in forward edge 368 of bezel 339. The extension of button 364 from its depressed to its non-activated or undepressed state, in turn, causes such other keyboard to become active and renders keyboard 325 inactive. It will be appreciated, that the spring-biased, depressible button 364 and corresponding cavity 366 can be replaced with other suitable switching means to make the upwardly facing keyboard active and render the downwardly facing keyboard inactive.

The foregoing embodiments have illustrated the invention in the context of a two-sided input device for a computer-related apparatus in the form of a computer system running software applications. The input device of the present invention is not limited to two-sided embodiments and, likewise, the computer related apparatuses controlled by such devices encompass more than traditional computers, including any number of electronic devices with CPU's, semiconductors or other computational devices incorporated therein. This includes multi-media systems with multiple electronic subsystems, personal digital assistance (PDAs), cellphones, game consoles or systems, CD/DVD players, stereos and the like.

Referring now to FIGS. 10A-10C, a multi-sided input device, illustrated as four-sided for this embodiment, is useful for operating one or more electronic apparatuses. The electronic apparatuses can be either separate, stand-alone apparatuses or systems, or can be subsystems of a multi-media system. Multi-sided input device 419 includes multiple, user-accessible surfaces 421, 423, 425, 437 each such surface having a corresponding set of input controls disposed thereon. Each of the sets of input controls are generally substantially sufficient to operate at least one of the electronic apparatuses associated with input device 419.

Surface 421 has a set of input controls comprising game controls 427 suitable for operating either a stand alone game system, such as manufactured by Nintendo or Sony, or for operating gaming applications run on a personal computer. The particular game controls comprising the game controls at 427 vary depending on the particular make, model, or sophistication of the game system, as well as the type of game. As such, those shown are exemplary only. Game controls 427 include four buttons, optionally equipped with suitable markings (not shown), for corresponding commands of particular games, such buttons being activatable or depressible separately or in combinations to perform desire functions associated with the game. Similarly, a set of four directional indications is provided for navigation, movement or other similar activities associated with games.

Referring now to FIG. 10B, surface 423 has a set of input controls 429 for a television. Again, the television can either be a stand-alone unit or part of a larger, multi-media system. Any of a variety of buttons for operation of a television comprise the input controls set 429, including alphanumerical keys 431, electronic program guide keys 433, and various navigation keys and function buttons suitable for operating a television and readily apparent to those skilled in the art.

Referring now to FIG. 10C, an alphanumeric keyboard comprises the third set of input controls 435. Alphanumeric keyboard 435 is suitable for operating any number of electronic apparatuses or multi-media subsystems which receive input from such keyboards, including a computer, a television adapted for use with a keyboard, and the like.

Still referring to FIG. 10C, surface 437 has a fourth set of input controls 439 disposed thereon and adapted for use with an audio entertainment system, such as a stereo, CD player or DVD, alone or in combination. Again, the particular input controls comprising audio controls 439 can be chosen depending on the particular stereo or audio functions to be performed, including selection between different audio frequency bands, different preset stations, different navigation options for audio media, such as cassette tapes, CDs and DVDs, and different indicia relating to MP3 functions and related controls. In the illustrated embodiment, an alphanumeric keypad permits tuning, while there are other function buttons permitting navigation. There is optionally a display screen 441 so that pertinent information, such as MP3 tags, station settings, and the like can be displayed for the operator of stereo controls 439.

The input device 419 is equipped with suitable means so that it can be operatively connected to the electronic apparatuses associated with the device 419. Thus, input device 419 can be in the form of a remote, in which suitable control functions are “beamed” to electronic apparatus by any number of remote control signaling methods known in the art. Alternatively, input device 419 can have a cable or other physical, electrical/electronic connection connecting to the one or more electronic apparatuses associated with it.

The block-like form of input device 419 means that, for any given orientation, one set of input controls is either facing downwardly or disposed against a corresponding horizontal surface upon which input device 419 may be placed. Input device 419 is optionally equipped with the ability to activate a selected set of controls and deactivate the others. For example, a gravity switch shown schematically at 441 operatively connects the upwardly facing set of input controls to the corresponding electronic apparatus or apparatuses. Gravity switch 441 is responsive to rotation of the module to activate the upwardly facing set input controls. Alternatively, a mechanical switch for selecting between the four available sets of input controls can be provided on input device 419.

Although input device 419 preferably has its elongated side surfaces 421, 423, 425 and 437 equipped with corresponding sets of input controls, the ends 443, 445 can alternately be equipped with one or more input controls or sets of input controls, either instead of or in addition to disposing such controls on the longitudal sides of the device 419.

Referring now to FIGS. 11A-11C, a multi-sided input device 519 is associated with a combination cellphone and calculator 517 in a housing 520 with display screen 522. Input device 519 includes input control nodule 535 of generally planar configuration, with one set of input controls 527 comprising an alphanumeric keypad 528 with alphanumeric keys 530 in a standard configuration therein. On the opposite side of input control module 535, a second set 531 of input controls is disposed. Second set of 531 input controls comprises a calculator keypad 533.

Input control 535 is removably secured to housing 520 in such a way that one of the sets of input controls 527 or 531 is facing outwardly for user access and the other set is facing inwardly, hidden from or inaccessible to the user. Input control module 535 is further provided with suitable connections, preferably electrical in nature, so that at least the outwardly facing set of input controls is operatively connected to the remaining electronics of the combination calculator PDA.

A tether keeps input control module 535 physically associated with its corresponding electronic apparatus, in this case, combination calculator-PDA. Tether 537 optionally includes wiring or other electrical connections to operatively connect input control module 535 to the electronic apparatus.

Referring now to FIGS. 12A-12C, electronic apparatus 617 in the form of a combination PDA-cellphone includes an input control module 635 similar to module 535 of FIGS. 11A-11C, but with first set of input controls 627 comprising an alphanumeric keypad 630 for the cellphone function and a second set of input controls 631 comprising a touch pad 633. As in the previous alternative embodiment illustrated in FIGS. 11A-11C, electronic apparatus 617 comprises an “integrated” apparatus in the sense that the input control module 635 and the other components and features of electronic apparatus 617 are physically secured to a housing 620.

Display screen 622 operates in conjunction with both sets of input controls 627, 631. In particular, display screen 622 displays phone numbers and other related cellphone functions when alphanumeric keypad 630 is in the user accessible position shown in FIG. 12A and being operated by the user. Display screen 622 displays inputs and outputs and other corresponding features related to operation of the PDA by means of touchpad 633, along with displaying other information associated with operations of the PDA aspect of electronic apparatus 617.

Electronic apparatus 617 preferably includes at least one input control 639 which is not part of input control module 635 and is thus not movably mounted to housing 620. Nonetheless, input control 639 works in conjunction with input control module 635. In the illustrated embodiment, input control 639 is suitably secured or fixed to housing 620 near the input controls of control module 635.

Input control module 639 changes function depending on which of the sets of input controls 631, 635 is in operative position. Thus, fixed input control 639 functions as a redial button 641 when the alphanumeric keypad is in operative position (FIG. 12A) and as a mouse button 643 when the touch pad is in operative position (FIG. 12C).

Referring now to FIGS. 13A and 13B, a multi-sided input device for operating one or more electronic apparatuses is in the form of a two sided remote 719 with two oppositely facing surfaces 721, 723. A first set of input controls 727 is disposed on surface 721 and corresponds to controls associated with operating a television. Input control set 727 includes a numeric keypad for channel entry and various navigation and function buttons for the television and associated system. It is understood, of course, that the television remote optionally includes any of the variety of functions which are indirectly related to operating a television, including cable system functions, VCR functions, DVD functions, and the like.

The second set of input controls 731 comprises a game pad 733 with suitable navigation, control and functional buttons for playing any of the myraid games available on game consoles or computers. Two sided remote 719 may be adapted for use with a multi-media system shown schematically at 717 and preferably comprising a television and a gaming console. Alternately, two-sided remote 719 can be adapted to operate a television and a gaming console when such systems are logically separate from each other.

Referring now to FIGS. 14A-14B, yet another alternative embodiment of a multi-sided input device is shown at 819 in the form of a two-sided remote similar to that of FIGS. 13A and 13B, but with second set of input controls 831 comprising input controls useful for a stereo or other audio system. The use of two-sided remote 819 proceeds similarly to the previously described embodiments. Input controls 831 include a display screen integrated into housing 820 for showing MP3 tag information, audio stations and the like.

The multi-sided input device may include still further alternative arrangements of input controls and alternative sets of input controls, depending on the particular electronic apparatus or apparatuses to be operated.

It is understood that the above-described preferred embodiments are but one illustration of the present invention, and that further alternative embodiments may be devised by those of ordinary skill in the art. Such alternatives, as well as others which skill or fancy may suggest, are considered to fall within the scope of the current invention, which is solely defined by the claims appended hereto.

What is claimed is:

1. A multi-sided input device useful for operating one or more corresponding computer-related apparatuses, the device comprising:
at least two sets of input controls;
a module having a plurality of substantially planar surfaces, the surfaces including first and second opposite surfaces each having a corresponding set of input controls disposed thereon;
means for positioning a selected one of the sets of input controls in a more user-accessible position,
wherein each of the sets of input controls has a sufficient number of the input controls to operate the corresponding computer-related apparatus;
means for operatively connecting one of the sets to the computer-related apparatus, whereby operation of the selected set of input controls is transmitted to the computer-related apparatus;
a base having portions defined so as to movably secure the module to the base, the portions of the base configured so that one of the sets of input controls is substantially inaccessible while at least one of the other sets is more readily accessible;
means for movably securing the module to the base.

2. The device of claim 1, in which the computer-related apparatus comprises a combination personal digital assistant (PDA) and cellphone in a housing having a display integrated therein, the module of the input device having a generally planar configuration, the first set of input controls comprising a keypad and the second set of input controls comprising a touchpad, the module configured to be removably secured to the housing with one of the sets of input controls facing outwardly for user access and the other set facing inwardly, the module configured so that the outwardly facing set of input controls is operatively connected to the combination PDA-cellphone and to the display screen.

3. The device of claim 2, further comprising at least one fixed input control integrally secured to the housing, the input control changing function depending on which of the sets of input controls is in operative position.

4. The device of claim 3, wherein the fixed input control functions as a redial button when the keypad is in operative position and as a mouse button when the touchpad is in operative position.

5. The device of claim 2, wherein the module is connected relative to the housing by means of a tether.

6. The device of claim 1, wherein the computer-related apparatus comprises a combination calculator-cellphone in a housing having a display screen integrated therein, the module of the input device having a generally planar configuration, the first set of input controls comprising an alphanumeric keypad and the second set of input controls comprising a calculator keypad, the module configured to be removably secured to the housing with one of the sets of input controls facing outwardly for user access and the other set facing inwardly, the module further configured so that the outwardly facing set of input controls is operatively connected to the combination calculator-cellphone.

7. A multi-sided input device useful for operating one or more corresponding computer-related apparatuses, the device comprising:
at least two sets of input controls;
a module having a plurality of substantially planar surfaces defined on the device, the surfaces including first and second opposite surface each having a corresponding set of input controls disposed thereon;
means for positioning a selected one of the sets of input controls in a more user-accessible position,
wherein each of the set of input controls has a sufficient number of the input controls to operate the corresponding computer-related apparatus;
wherein the module comprises a two-sided remote for operating at least two computer-related apparatuses selected from the group consisting of a computer for associated applications or the internet, a television, a CD/DVD player, a stereo and a game player.

8. The device of claim 7, wherein one of the computer-related apparatuses comprises a TV, and wherein the remote includes a set of input controls having TV-related functions.

9. The device of claim 7, wherein the two, computer-related apparatuses include a stereo.

10. The device of claim 7, wherein the two, computer-related apparatuses include a game console.

11. A multi-sided input device for operating one or more electronic apparatuses, the device comprising:
at least three sets of input controls, each set sufficient to operate at least one of the electronic apparatuses;
a plurality of user-accessible surfaces, the surfaces sized to contain substantially all of the input controls of a corresponding set.

12. The device of claim 11, further comprising means for operatively connecting a selected one of the sets of input controls to a corresponding electronic apparatus.

13. The device of claim 12, wherein the connecting means comprises a gravity switch responsive to rotation of the module to activate a set of input controls in a user-accessible position.

14. The device of claim 11, wherein one of the electronic apparatuses comprises a computer, wherein the input device operates two different software applications on the computer, and wherein the module comprises two corresponding sets of input controls for the two different software applications.

15. The device of claim 11, wherein the surfaces on which the sets of input controls are disposed are substantially planar.

16. The device of claim 11, wherein the input device comprises a housing with an outer surface, and the user-accessible surfaces are arranged to face outwardly along the outer surface of the housing.

17. The device of claim 11, wherein the input device has a somewhat block-shaped form, the surfaces on which the sets of input controls are disposed comprising faces of the block-like form.

18. The device of claim 17, further comprising four sets of the input controls, wherein the input device has two opposite end faces and four side faces, the user-accessible surfaces on which the input controls are disposed corresponding to the four side faces.

19. The device of claim 18, wherein the four sets of input controls comprise an alphanumeric keyboard, a stereo remote, a TV remote, and a game controller.

20. A multi-media system, the system having a plurality of electronic subsystems for reading or processing information from corresponding information sources, the subsystems selected from the group consisting of a computer for associated applications or the internet, a television, a CD/DVD player, a stereo and a game console, the system further comprising a multi-sided input device for operating the plurality of subsystems, the input device comprising input controls grouped into sets sufficient to operate at least one corresponding electronic subsystem, the device further comprising a plurality of user activatable surfaces, the surfaces sized to contain substantially all of the input controls of a corresponding set.

21. The system of claim 20, comprising a television and another electronic subsystem, wherein the input device comprises a two-sided remote having TV controls on one side and controls for the electronic subsystem on the other side.

22. The system of claim 20, comprising two different electronic subsystems, wherein the input device comprises two sets of input controls, one for each of the two different electronic subsystems.

23. The system of claim 22, wherein the two electronic subsystems comprise the computer and another one of the electronic subsystems, wherein one set of input controls comprises an alphanumeric keyboard.

24. The system of claim 20, further comprising a base to which the input control device is secured.

25. The system of claim 24, wherein the input control device is rotatably secured to the base so that rotation of the input control device brings the surfaces on which the sets of input controls are disposed into more user accessible positions in a serial fashion as the device is rotated.

26. The system of claim 24, wherein the input device is removably mounted to the base to switch between different sets of input controls by removing the input control device from the base, repositioning it, and resecuring it to the base.

27. The system of claim 24, wherein the input control device is operatively associated with the system but it a separate component therefrom.

28. The system of claim 24, wherein the input control device is integrated into a housing of the system.
